(19) United States
(12) Patent Application Publication
(10) Pub. No.: US 2022/0386235 A1
(43) Pub. Date: Dec. 1, 2022

(54) DYNAMIC POWER SAVING IN A WIRELESS DEVICE IN A WIRELESS COMMUNICATIONS SYSTEM (WCS)

(71) Applicant: Corning Research & Development Corporation, Corning, NY (US)

(72) Inventors: Lior Michael Kruh, Sunnyvale, CA (US); Shirish Nagaraj, Pleasanton, CA (US); Deepak Pengoria, Milpitas, CA (US); Hsien Li Woo, San Diego, CA (US)

(21) Appl. No.: 17/825,725

(22) Filed: May 26, 2022

Related U.S. Application Data
(60) Provisional application No. 63/193,532, filed on May 26, 2021.

(51) Int. Cl. H04W 52/02; H04W 64/00; H04W 4/02

(52) U.S. Cl. CPC H04W 52/0206; H04W 64/006; H04W 4/023

(57) ABSTRACT

Dynamic power saving in a wireless device in a wireless communications system (WCS) is disclosed. The WCS includes a wireless device(s), such as a fifth-generation (5G) or a 5G new-radio (NR) base station (eNB), configured to communicate downlink and uplink communications signals in a coverage cell. In embodiments disclosed herein, the wireless device(s) can determine whether a power-saving condition is met in the coverage cell, and opportunistically operate in a power-saving mode when the power-saving condition is met. By opportunistically operating in the power-saving mode based on the power-saving condition, it is possible to reduce power consumption in the wireless device(s) without sacrificing user experience in the coverage cell.

### CROSS-REFERENCE TO RELATED APPLICATIONS

This application claims the benefit of priority under 35 U.S.C. § 119 of U.S. Provisional Application Serial No. 63/193,532, filed May 26, 2021, the content of which is relied upon and incorporated herein by reference in its entirety.

### BACKGROUND

The disclosure relates generally to power saving schemes in a wireless device (e.g., a remote unit) in a wireless communications system (WCS), which can include a fifth-generation (5G) or a 5G new-radio (5G-NR) system and/or a distributed communications system (DCS).

Wireless communication is rapidly growing, with ever-increasing demands for high-speed mobile data communication. As an example, local area wireless services (e.g., so-called “wireless fidelity” or “WiFi” systems) and wide area wireless services are being deployed in many different types of areas (e.g., coffee shops, airports, libraries, etc.). Communications systems have been provided to transmit and/or distribute communications signals to wireless devices called “clients,” “client devices,” or “wireless client devices,” which must reside within the wireless range or “cell coverage area” in order to communicate with an access point device. Example applications where communications systems can be used to provide or enhance coverage for wireless services include public safety, cellular telephony, wireless local access networks (LANs), location tracking, and medical telemetry inside buildings and over campuses. One approach to deploying a communications system involves the use of radio nodes/base stations that transmit communications signals distributed over physical communications medium remote units forming RF antenna coverage areas, also referred to as “antenna coverage areas.” The remote units each contain or are configured to couple to one or more antennas configured to support the desired frequency(ies) of the radio nodes to provide the antenna coverage areas. Antenna coverage areas can have a radius in a range from a few meters up to twenty meters, as an example. Another example of a communications system includes radio nodes, such as base stations, that form cell radio access networks, wherein the radio nodes are configured to transmit communications signals wirelessly directly to client devices without being distributed through intermediate remote units.

For example, FIG. 1 is an example of a WCS 100 that includes a radio node 102 configured to support one or more service providers 104(1)-104(N) as signal sources (also known as “carriers” or “service operators”—e.g., mobile network operators (MNOs)) and wireless client devices 106(1)-106(W). For example, the radio node 102 may be a base station (eNodeB) that includes modem functionality and is configured to distribute communications signal streams 108(1)-108(S) to the wireless client devices 106(1)-106(W) based on communications signals 110(1)-110(N) received from the service providers 104(1)-104(N). The communications signal streams 108(1)-108(S) of each respective service provider 104(1)-104(N) in their different spectrums are radiated through an antenna 112 to the wireless client devices 106(1)-106(W) in a communication range of the antenna 112. For example, the antenna 112 may be an antenna array. As another example, the radio node 102 in the WCS 100 in FIG. 1 can be a small cell radio access node (“small cell”) that is configured to support the multiple service providers 104(1)-104(N) by distributing the communications signal streams 108(1)-108(S) for the multiple service providers 104(1)-104(N) based on respective communications signals 110(1)-110(N) received from a respective evolved packet core (EPC) network CN₁-CN_{N} of the service providers 104(1)-104(N) through interface connections. The radio node 102 includes radio circuits 118(1)-118(N) for each service provider 104(1)-104(N) that are configured to create multiple simultaneous signal beams (“beams”) 120(1)-120(N) for the communications signal streams 108(1)-108(S) to serve multiple wireless client devices 106(1)-106(W). For example, the multiple beams 120(1)-120(N) may support multiple-input, multiple-output (MIMO) communications.

The radio node 102 of the WCS 100 in FIG. 1 may be configured to support service providers 104(1)-104(N) that have a different frequency spectrum and do not share the spectrum. Thus, in this instance, the communications signals 110(1)-110(N) from the different service providers 104(1)-104(N) do not interfere with each other even if transmitted by the radio node 102 at the same time. The radio node 102 may also be configured as a shared spectrum communications system where the multiple service providers 104(1)-104(N) have a shared spectrum. In this regard, the capacity supported by the radio node 102 for the shared spectrum is split (i.e., shared) between the multiple service providers 104(1)-104(N) for providing services to the subscribers.

The WCS 100 may be configured to operate as a fifth generation (5G) or a 5G new-radio (5G-NR) communications system. In this regard, the radio node 102 can function as a 5G or 5G-NR base station (a.k.a. eNB) to service the wireless client devices 106(1)-106(W) in a coverage cell. In this regard, the radio node 102 can be configured to communicate the communications signals 110(1)-110(N) in frequency range (FR) 1 (below 6 GHz) or FR 2 (above 24 GHz), which is commonly referred to as the millimeter wave (mmWave) spectrum. In this regard, the radio node 102 can simultaneously radiate the beams 120(1)-120(N) to the client devices 106(1)-106(W) from tens or even hundreds of the antenna 112. As such, the radio node 102 may consume a substantial amount of power when operating in an active mode to communicate the communications signals 110(1)-110(N) in the mmWave spectrum. As such, it is desired to configure the radio node 102 to opportunistically operate in a power-saving mode to help reduce power consumption in the radio node 102.

No admission is made that any reference cited herein constitutes prior art. Applicant expressly reserves the right to challenge the accuracy and pertinency of any cited documents.

### SUMMARY

Embodiments disclosed herein include dynamic power saving in a wireless device in a wireless communications system (WCS). The WCS includes a wireless device(s), such as a fifth-generation (5G) or a 5G new-radio (NR) base station (eNB), configured to communicate downlink and uplink communications signals in a coverage cell. In embodiments disclosed herein, the wireless device(s) can determine whether a power-saving condition is met in the coverage cell, and opportunistically operate in a power-saving mode when the power-saving condition is met. By opportunistically operating in the power-saving mode based on the power-saving condition, it is possible to reduce power consumption in the wireless device(s) without sacrificing user experience in the coverage cell.

One exemplary embodiment of the disclosure relates to a wireless device. The wireless device includes a plurality of antenna elements each configured to radiate a downlink communications signal and receive an uplink communications signal in a coverage cell. The wireless device also includes a control circuit. The control circuit is configured to cause the wireless device to operate in an active mode. The control circuit is also configured to determine if a power-saving condition is present in the coverage cell. The control circuit is also configured to, in response to the power-saving condition being present, cause the wireless device to operate in a power-saving mode.

An additional exemplary embodiment of the disclosure relates to a method for supporting dynamic power saving in a wireless device in a WCS. The method includes causing the wireless device to operate in an active mode. The method also includes determining if a power-saving condition is present in a coverage cell served by the wireless device. The method also includes, in response to the power-saving condition being present, causing the wireless device to operate in a power-saving mode.

An additional exemplary embodiment of the disclosure relates to a WCS. The WCS includes a wireless device. The wireless device includes a plurality of antenna elements each configured to radiate a downlink communications signal and receive an uplink communications signal in a coverage cell. The wireless device also includes a control circuit. The control circuit is configured to cause the wireless device to operate in an active mode. The control circuit is also configured to determine if a power-saving condition is present in the coverage cell. The control circuit is also configured to, in response to the power-saving condition being present, cause the wireless device to operate in a power-saving mode.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a schematic diagram of an exemplary wireless communications system (WCS), such as a distributed communications system (DCS), configured to distribute communications services to remote coverage areas;

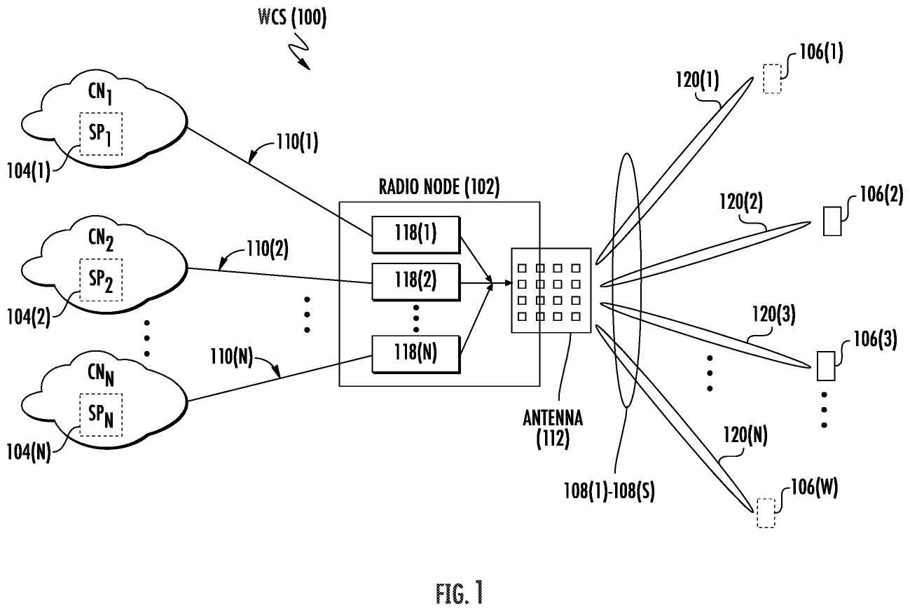

FIG. 2A is a schematic diagram of an exemplary fifth-generation (5G) frame structure as defined in third-generation partnership project (3GPP) standards;

FIG. 2B provides an exemplary illustration of time-division duplex (TDD) downlink/uplink configurations as defined for the 5G frame structure in FIG. 2A in 3GPP technical specification (TS) 36.211;

FIG. 3 is a schematic diagram of an exemplary WCS configured according to any of the embodiments disclosed herein to enable dynamic power saving;

FIG. 4 is a schematic diagram of an exemplary wireless device configured according to embodiments of the present disclosure to support dynamic power saving in the WCS of FIG. 3;

FIG. 5 is a flowchart of an exemplary process that can be employed by the wireless device of FIG. 4 to support dynamic power saving;

FIG. 6A is a schematic diagram of an exemplary fourth-generation (4G)/5G non-standalone communications system in which a legacy base station(s) is configured to help the wireless device of FIG. 4 to detect a user equipment (UE) approaching a coverage cell of the wireless device from outside the coverage cell;

FIG. 6B is a schematic diagram providing an exemplary illustration of the 4G/5G non-standalone communications system of FIG. 6A further configured to detect a UE moving away from the coverage cell of the wireless device of FIG. 4;

FIG. 7 is a schematic diagram of an exemplary state machine that can be employed by the wireless device of FIG. 4 to enable dynamic power saving;

FIG. 8 is a partial schematic cut-away diagram of an exemplary building infrastructure in a WCS, such as the WCS of FIG. 3 that includes the wireless device of FIG. 4 for supporting dynamic power saving in the wireless device;

FIG. 9 is a schematic diagram of an exemplary mobile telecommunications environment that can includes the WCS of FIG. 3 that includes the wireless device of FIG. 4 for supporting dynamic power saving in the wireless device; and

FIG. 10 is a schematic diagram of a representation of an exemplary computer system that can be included in or interfaced with any of the components in the WCS of FIG. 3 and the wireless device in FIG. 4 for support power saving in the wireless device, wherein the exemplary computer system is configured to execute instructions from an exemplary computer-readable medium.

### DETAILED DESCRIPTION

Embodiments disclosed herein include dynamic power saving in a wireless device in a wireless communications system (WCS). The WCS includes a wireless device(s), such as a fifth-generation (5G) or a 5G new-radio (NR) base station (eNB), configured to communicate downlink and uplink communications signals in a coverage cell. In embodiments disclosed herein, the wireless device(s) can determine whether a power-saving condition is met in the coverage cell, and opportunistically operate in a power-saving mode when the power-saving condition is met. By opportunistically operating in the power-saving mode based on the power-saving condition, it is possible to reduce power consumption in the wireless device(s) without sacrificing user experience in the coverage cell.

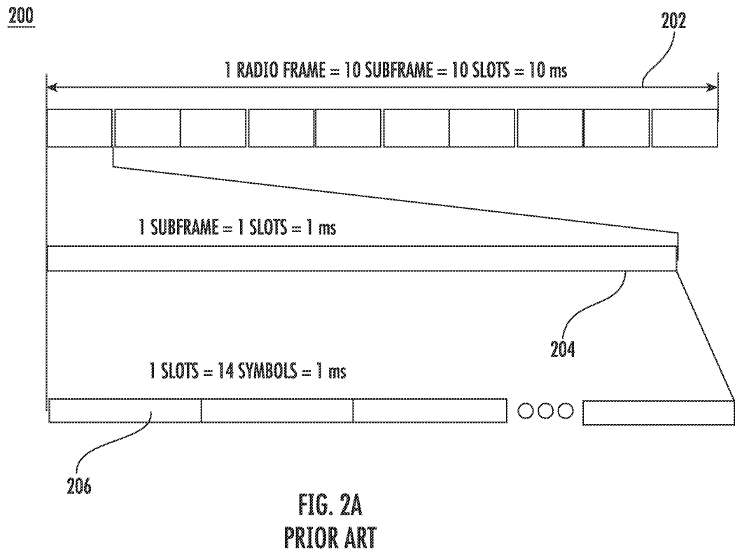

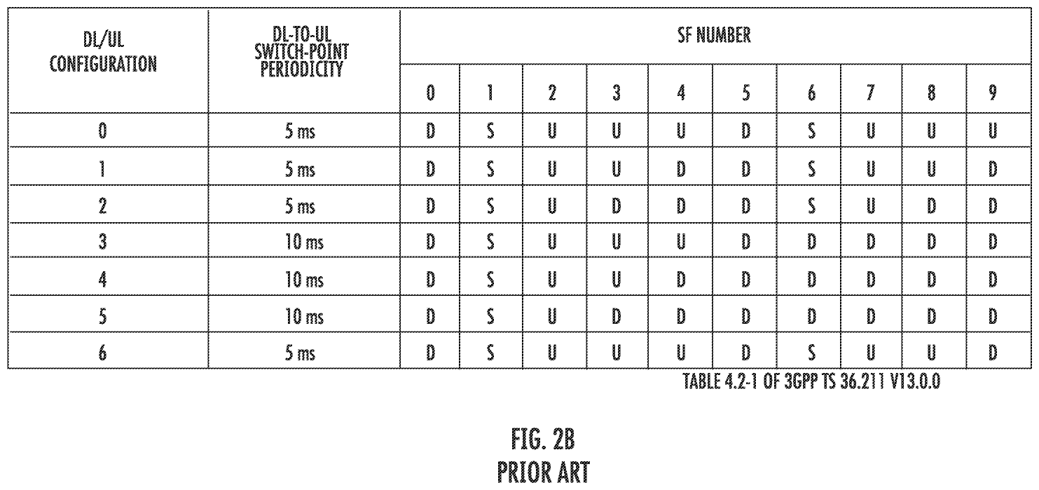

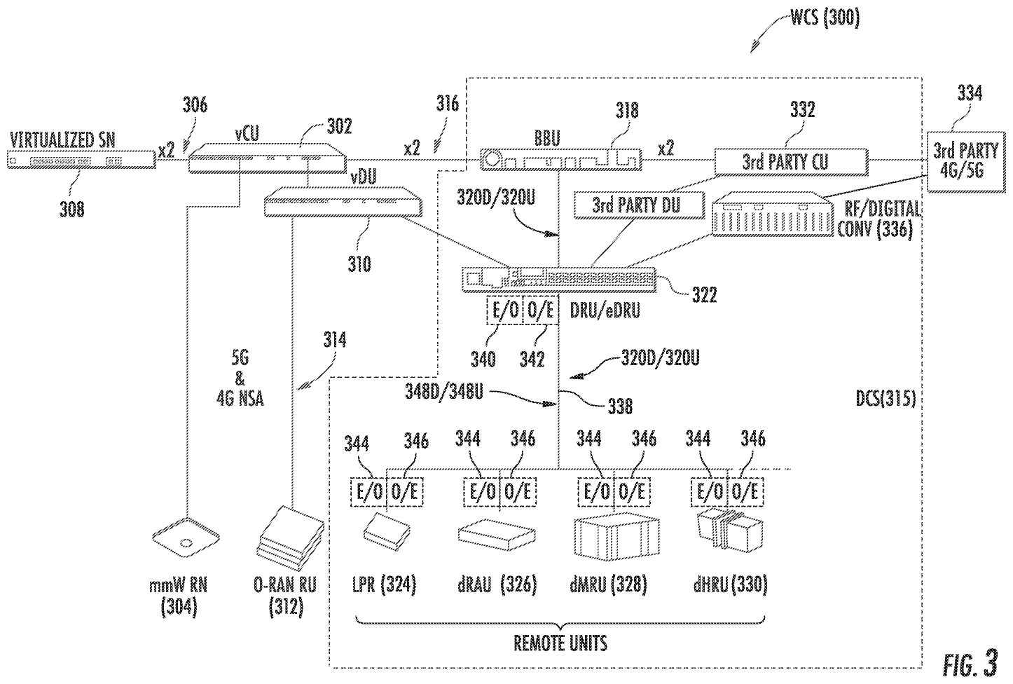

Before discussing dynamic power-saving in a wireless device in a WCS according to the present disclosure, starting at FIG. 3, an overview of a 5G frame structure (a.k.a. frame structure type 2 (FS2)) and a corresponding time-division duplex (TDD) slot configuration scheme is first provided with reference to FIGS. 2A-2B.

In this regard, FIG. 2A is a schematic diagram of an exemplary 5G frame structure 200 (a.k.a. FS2) as defined in third-generation partnership project (3GPP) standards. As shown in FIG. 2A, a radio frame(s) 202 in FS2 has a frame length of 10 milliseconds (ms). The radio frame(s) 202 is further divided into ten (10) subframes (SFs) 204 (a.k.a. timeslots) each lasting 1 ms. Each of the SFs 204 can be configured to include 14 orthogonal frequency division multiplexing (OFDM) symbols 206.

The 5G frame structure 200 can be configured to support downlink and uplink communications based on a TDD configuration. In this regard, FIG. 2B provides an exemplary illustration of TDD downlink/uplink configurations as defined for the 5G frame structure 200 of FIG. 2A in 3GPP technical specification (TS) 36.211 V13.0.0.0.

In TDD, a subset of SFs 204 in the 5G radio frame 202 is reserved for uplink transmissions, and the remaining SFs are allocated for downlink transmissions, or for special SFs, where the switch between downlink and uplink occurs. As shown in FIG. 2B, seven different downlink/uplink configurations are supported for the 5G frame structure 200. Here, “D” denotes a downlink SF, “U” denotes an uplink SF, and “S” represents a special SF. Configurations 0, 1, 2, and 6 have a 5 ms downlink-to-uplink switch-point periodicity, with the special SF existing in both SF 1 and SF 6. Configurations 3, 4, and 5 have a 10 ms downlink-to-uplink switch-point periodicity, with the special SF in SF 1 only. A special SF is split into three parts, namely a downlink part (downlink part of a special subframe (DwPTS)), guard period (GP), and an uplink part of a special subframe (UpPTS). The DwPTS with a duration of more than three symbols can be treated as a normal downlink SF for data transmission. As discussed in detail below, it is possible to opportunistically nullify some of the downlink SF, the uplink SF, and/or the special SF in the radio frame(s) 202 to help conserve energy in a wireless device (e.g., eNB) that communicates based on the 5G frame structure 200.

In this regard, FIG. 3 is a schematic diagram of an exemplary WCS 300 configured according to any of the embodiments disclosed herein to support dynamic power saving. The WCS 300 supports both legacy 4G LTE, 4G/5G non-standalone (NSA), and 5G standalone communications systems. As shown in FIG. 3, a centralized services node 302 is provided that is configured to interface with a core network to exchange communications data and distribute the communications data as radio signals to remote units. In this example, the centralized services node 302 is configured to support distributed communications services to an mmWave radio node 304. Despite that only one of the mmWave radio node 304 is shown in FIG. 3, it should be appreciated that the WCS 300 can be configured to include additional numbers of the mmWave radio node 304, as needed. The functions of the centralized services node 302 can be virtualized through an x2 interface 306 to another services node 308. The centralized services node 302 can also include one or more internal radio nodes that are configured to be interfaced with a distribution unit (DU) 310 to distribute communications signals to one or more open radio access network (O-RAN) remote units (RUs) 312 that are configured to be communicatively coupled through an O-RAN interface 314. The O-RAN RUs 312 are each configured to communicate downlink and uplink communications signals in a respective coverage cell.

The centralized services node 302 can also be interfaced with a distributed communications system (DCS) 315 through an x2 interface 316. Specifically, the centralized services node 302 can be interfaced with a digital baseband unit (BBU) 318 that can provide a digital signal source to the centralized services node 302. The digital BBU 318 may be configured to provide a signal source to the centralized services node 302 to provide downlink communications signals 320D to a digital routing unit (DRU) 322 as part of a digital distributed antenna system (DAS). The DRU 322 is configured to split and distribute the downlink communications signals 320D to different types of remote units, including a low-power remote unit (LPR) 324, a radio antenna unit (dRAU) 326, a mid-power remote unit (dMRU) 328, and a high-power remote unit (dHRU) 330. The DRU 322 is also configured to combine uplink communications signals 320U received from the LPR 324, the dRAU 326, the dMRU 328, and the dHRU 330 and provide the combined uplink communications signals to the digital BBU 318. The digital BBU 318 is also configured to interface with a third-party central unit 332 and/or an analog source 334 through a radio frequency (RF)/digital converter 336.

The DRU 322 may be coupled to the LPR 324, the dRAU 326, the dMRU 328, and the dHRU 330 via an optical fiber-based communications medium 338. In this regard, the DRU 322 can include a respective electrical-to-optical (E/O) converter 340 and a respective optical-to-electrical (0/E) converter 342. Likewise, each of the LPR 324, the dRAU 326, the dMRU 328, and the dHRU 330 can include a respective E/O converter 344 and a respective O/E converter 346.

The E/O converter 340 at the DRU 322 is configured to convert the downlink communications signals 320D into downlink optical communications signals 348D for distribution to the LPR 324, the dRAU 326, the dMRU 328, and the dHRU 330 via the optical fiber-based communications medium 338. The O/E converter 346 at each of the LPR 324, the dRAU 326, the dMRU 328, and the dHRU 330 is configured to convert the downlink optical communications signals 348D back to the downlink communications signals 320D. The E/O converter 344 at each of the LPR 324, the dRAU 326, the dMRU 328, and the dHRU 330 is configured to convert the uplink communications signals 320U into uplink optical communications signals 348U. The O/E converter 342 at the DRU 322 is configured to convert the uplink optical communications signals 348U back to the uplink communications signals 320U.

In a non-limiting example, the mmWave radio node 304 is a 5G or a 5G NR eNB and the O-RAN RU 312 is a legacy LTE eNB. In this regard, the WCS 300 is configured to operate based on the 4G/5G NSA configuration. With the 4G/5G NSA configuration, the mmWave radio node 304 is configured to communicate in a smaller coverage cell, whereas the O-RAN RU 312 will be communicating in a larger coverage cell that encompasses the smaller coverage cell of the mmWave radio node 304. A user equipment (UE), on the other hand, may be required to connect simultaneously to the mmWave radio node 304 and the O-RAN RU 312 when the UE is located in an overlapping coverage area of both the mmWave radio node 304 and the O-RAN RU 312. In contrast, when the UE is outside the smaller coverage cell of the mmWave radio node 304 but inside the larger coverage cell of the O-RAN RU 312, the UE may maintain a connection only to the O-RAN RU 312. As such, as discussed below, it is possible for the mmWave radio node 304 to opportunistically enter power-saving mode to help reduce power consumption when the mmWave radio node 304 determines that no UE is currently located in and/or approaching the smaller coverage cell of the mmWave radio node 304.

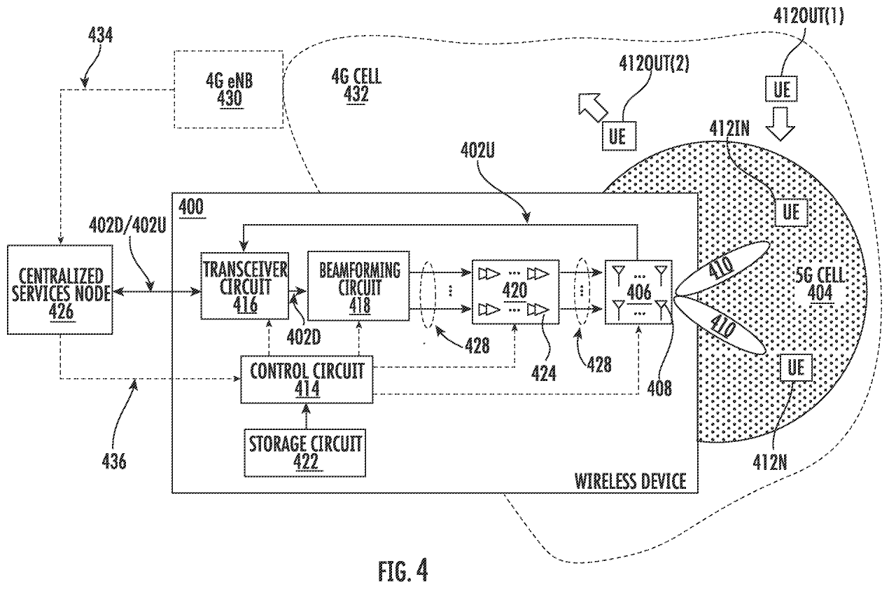

In this regard, FIG. 4 is a schematic diagram of an exemplary wireless device 400 configured according to embodiments of the present disclosure to support dynamic power saving in the WCS 300 of FIG. 3. The wireless device 400 may be identical or functionally equivalent to the mmWave radio node 304 in the WCS 300 of FIG. 3. In this regard, in examples discussed herein, the wireless device 400 is a 5G or a 5G NR eNB configured to communicate a downlink communications signal 402D and an uplink communications signal 402U in a coverage cell 404 (denoted as “5G cell”). In a non-limiting example, the wireless device 400 is configured to communicate the downlink communications signal 402D and the uplink communications signal 402U in the mmWave spectrum (e.g., FR2) and based on the 5G frame structure 200 (a.k.a. FS2) of FIG. 2A.

Specifically, the wireless device 400 includes an antenna array 406 that includes a plurality of antenna elements 408. The antenna elements 408 are configured to form one or more RF beams 410 to radiate the downlink communications signal 402D toward one or more UEs 412IN located inside the coverage cell 404. In addition, the antenna elements 408 can also absorb the uplink communications signal 402U from the UEs 412IN.

The wireless device 400 includes a control circuit 414, which can be a field-programmable gate array (FPGA), a central processing unit (CPU), or an application-specific integrated circuit (ASIC), as an example. The control circuit 414 is configured to dynamically determine whether a power-saving condition is met in the coverage cell 404. If the power-saving condition is met, the control circuit 414 can cause the wireless device 400 to operate in a power-saving mode to thereby reduce power consumption in the wireless device 400. Otherwise, the control circuit 414 can cause the wireless device to operate in an active mode to help maximize coverage and/or throughput in the coverage cell 404. By opportunistically operating in the power-saving mode when the power-saving condition is met, it is possible to reduce power consumption in the wireless device 400 without sacrificing user experience in the coverage cell 404.

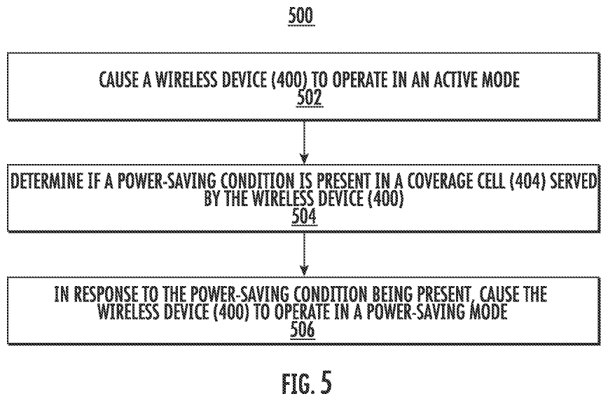

The wireless device 400 may be configured to support dynamic power saving based on a process. In this regard, FIG. 5 is a flowchart of an exemplary process 500 that can be employed by the wireless device 400 of FIG. 4 to support dynamic power saving.

According to the process 500, the control circuit 414 may cause the wireless device 400 to operate in an active mode (block 502). The control circuit 414 then determines if the power-saving condition is present in the coverage cell 404 (block 504). If the control circuit 414 determines that the power-saving condition is present, the control circuit 414 will cause the wireless device 400 to operate in the power-saving mode (block 506).

With reference back to FIG. 4, in a non-limiting example, the wireless device 400 further includes a transceiver circuit 416, a beamforming circuit 418, a power amplifier circuit 420, and a storage circuit 422. The power amplifier circuit 420 includes a plurality of power amplifiers 424, each coupled to a respective one of the antenna elements 408. The transceiver circuit 416 may be coupled to a centralized services node 426, which may be identical or functionally equivalent to the centralized services node 302 in the WCS 300 of FIG. 3. In this regard, the transceiver circuit 416 is configured to receive the downlink communications signal 402D from the centralized services node 426 and provides the uplink communications signal 402U to the centralized services node 426.

The beamforming circuit 418 is configured to convert the downlink communications signal 402D into a plurality of weighted downlink communications signals 428, each with a respective weight factor and a respective phase offset configured to provide phase coherency in the RF beams 410. Each of the power amplifiers 424 is configured to amplify a respective one of the weighted downlink communications signals 428 and provide the respective one of the weighted downlink communications signals 428 to the respective one of the antenna elements 408. Accordingly, the antenna elements 408 can form the RF beams 410 to radiate the downlink communications signal 402D to the UEs 412IN located in the coverage cell 404. In addition, the antenna elements 408 also absorb the uplink communications signal 402U transmitted from the UEs 412IN and provide the uplink communications signal 402U to the transceiver circuit 416.

The storage circuit 422 may include such storage devices as registers, memories, and solid-state drive (SSD) to store various configuration information, including but not limited to radius of the coverage cell 404, the power-saving condition, and various power-saving actions to be performed during the power-saving mode. The configuration information may be prestored or dynamically programmed into the storage circuit 422.

The control circuit 414 may perform one or more of the power-saving actions to help reduce power consumption in response to determining that the power-saving condition is met. For example, the control circuit 414 can control the transceiver circuit 416 to selectively nullify (e.g., skip) a subset of the timeslots 204, as illustrated in FIG. 2A, configured for transmitting the downlink communications signal 402D in the radio frame 202. In one embodiment, the control circuit can cause the transceiver circuit 416 to nullify the subset of the timeslots 204 in its entirety. In an alternative embodiment, the control circuit 414 can cause the transceiver circuit 416 to only nullify certain downlink SF and/or certain DwPTS in the special SF, as illustrated in FIG. 2B, in each of the subset of the timeslots 204.

The control circuit 414 may also control the antenna array 406 to deactivate a subset of the antenna elements 408, for example during the subset of the timeslots 204 that are nullified. The control circuit 414 may further control the power amplifier circuit 420 to deactivate a subset of the power amplifiers 424 that are coupled to the subset of the antenna elements 408 being deactivated. By opportunistically deactivating the subset of the antenna elements 408 and the subset of the power amplifiers 424, it is thus possible to significantly reduce power consumption of the wireless device 400.

The control circuit 414 may also control the beamforming circuit 418 and/or the antenna array 406 to radiate reference RF beams at an extended interval and/or via a reduced number of antenna elements. According to relevant 3GPP standards, the wireless device 400 can radiate up to 64 reference RF beams periodically such that a new UE can discover the wireless device 400 in the coverage cell 404 and thereby establish a connection with the wireless device 400. For example, the new UE, which may have just been powered up or entering the coverage cell 404, can sweep through the reference RF beams to identify a strongest one of the reference RF beams. Accordingly, the new UE may send a random-access channel (RACH) message to establish the connection with the wireless device 400. Understandably, by extending the interval and/or reducing the number of the antenna elements 408 for radiating the reference RF beams can result in a reduced dynamic range of the wireless device 400, thus hindering the ability of the new UE to establish the connection with the wireless device 400 in a timely manner.

In a non-limiting example, the control circuit 414 can determine whether the power-saving condition is met by determining whether a UE(s) is currently located inside the coverage cell 404 or approaching the coverage cell 404 from outside the coverage cell 404. In this regard, the power-saving condition can only be deemed as true when there is no UE currently located inside the coverage cell 404 and approaching the coverage cell 404 from outside the coverage cell 404.

In an embodiment, the wireless device 400 can determine whether any of the UEs 412IN are currently in the coverage cell 404 based on, for example, whether any of the UEs 412IN is currently connected to the wireless device 400 and/or attempting to establish a connection with the wireless device 400. For example, the control circuit 414 can determine that any of the UEs 412IN is currently connected to the wireless device 400 if one or more of a physical downlink control channel (PDCCH), a physical downlink shared channel (PDSCH), a physical uplink control channel (PUCCH), and a physical uplink shared channel (PUSCH) have been assigned to the UEs 412IN. The control circuit 414 may also determine that any of the UEs 412IN is attempting to establish the connection with the wireless device 400 if the UEs 412IN have transmitted the RACH message to request establishment of the connection with the wireless device 400. In this regard, the wireless device 400 may detect the UEs 412IN inside the coverage cell 404 when the wireless device 400 is deployed in both 4G/5G non-standalone and 5G standalone communications systems.

However, the wireless device 400 may be incapable of detecting the new UEs that are approaching the coverage cell 404 from outside the coverage cell 404, given that these new UEs may have not discovered the reference RF beams to thereby trigger the RACH messages destined to the wireless device 400. In this regard, the wireless device 400 would rely on a plurality of legacy base stations 430 (denoted as “4G eNB”) that coexist with the wireless device 400 in a 4G/5G non-standalone communications system (e.g., the WCS 300 of FIG. 3) to help detect the new UEs that are moving toward the coverage cell 404 from outside the coverage cell 404. Herein, the legacy base stations 430 refer to long-term evolution (LTE) base stations.

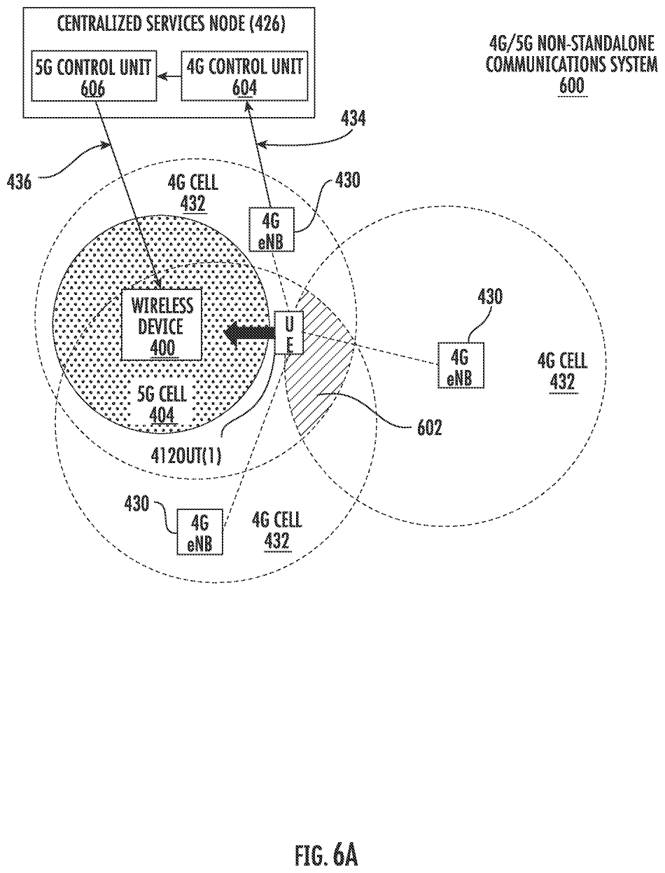

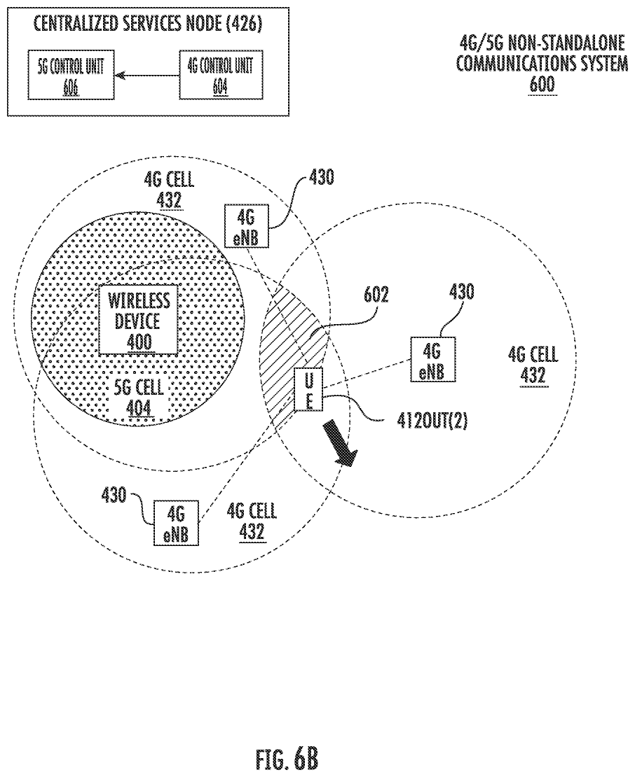

In the 4G/5G non-standalone communications system, the legacy base stations 430 may each provide a legacy coverage cell 432 that overlaps or encompasses the coverage cell 404 of the wireless device 400. In this regard, a subset of the legacy base stations 430 may be configured to collectively detect one or more UEs 412OUT(1) and 412OUT(2) that are located inside the legacy coverage cell 432 but outside the coverage cell 404 of the wireless device. As discussed next in FIGS. 6A and 6B, the legacy base stations 430 can collectively detect both the UE 412OUT(1), which is entering the coverage cell 404, and the UE 412OUT(2), which is moving away from the coverage cell 404.

Upon detecting that the UE 412OUT(1) is approaching the coverage cell 404 from outside the coverage cell 404, the legacy base stations 430 may provide a notification 434 to the centralized services node 426, which in turn provides an indication signal 436 to the control circuit 414 to indicate that the UE 412OUT(1) is approaching the coverage cell 404 from outside the coverage cell 404. In the meantime, the control circuit 414 may have determined that none of the UEs 412IN existed in the coverage cell 404 and thereby caused the wireless device 400 to operate in the power-saving mode to conserve energy. In this regard, in response to receiving the indication signal 436, the control circuit 414 can cause the wireless device 400 to transition from the power-saving mode to the active mode. For example, the control circuit 414 can control the transceiver circuit 416 and/or the antenna array 406 to radiate the reference RF beams more frequently and/or with higher energy such that the UE 412OUT(1) can quickly detect the wireless device 400 upon entering the coverage cell 404.

FIG. 6A is a schematic diagram of an exemplary 4G/5G non-standalone communications system 600 in which the legacy base stations 430 are configured to help the wireless device 400 of FIG. 4 to detect the UE 412OUT(1) approaching the coverage cell 404 from outside the coverage cell 404. Common elements between FIGS. 4 and 6A are shown therein with common element numbers and will not be re-described herein.

As shown in FIG. 6A, each of the legacy base stations 430 is associated with the legacy coverage cell 432 that either overlaps or encompasses the coverage cell 404 of the wireless device 400. The UE 412OUT(1), which may be located in an overlapping area 602 of the legacy coverage cells 432, can be detected by the legacy base stations 430 based on, for example, triangulations. Accordingly, one or more of the legacy base stations 430 can provide the notification 434 to a 4G control unit 604 in the centralized services node 426. The 4G control unit 604 may forward the notification 434, with or without further processing, to a 5G control unit 606, which in turn provides the indication signal 436 to the wireless device 400.

In addition to detecting the UE 412OUT(1) entering the coverage cell 404, the 4G/5G non-standalone communications system 600 may also detect the UE 412OUT(2) moving away from the coverage cell 404, as illustrated below in FIG. 6B. Common elements between FIGS. 6A and 6B are shown therein with common element numbers and will not be re-described herein.

Given that the UE 412OUT(2) is moving away from the coverage cell 404, the legacy base stations 430 will not provide the notification 434 to the 4G control unit 604. Accordingly, the 5G control unit 606 will not provide the indication signal 436 to the wireless device 400.

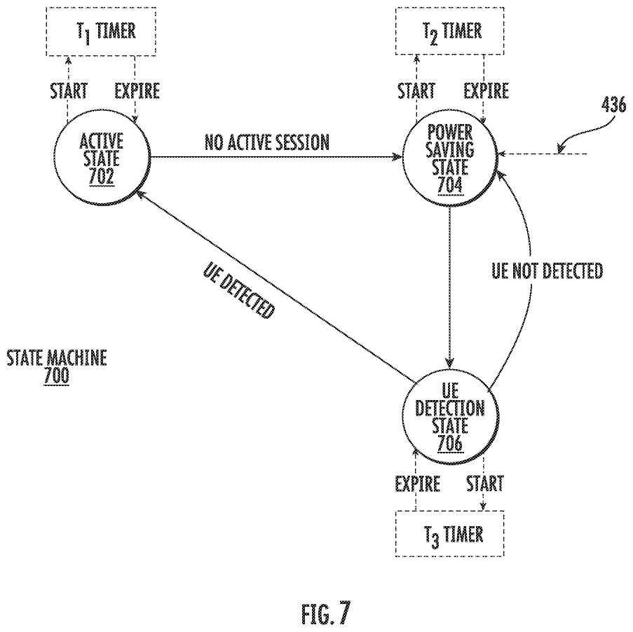

The control circuit 414 in the wireless device 400 of FIG. 4 can be configured to enable dynamic power saving by instantiating and executing a state machine. In this regard, FIG. 7 is a schematic diagram of an exemplary state machine 700 that can be employed by the control circuit 414 in the wireless device 400 of FIG. 4 to enable dynamic power saving. Common elements between FIGS. 4 and 7 are shown therein with common element numbers and will not be re-described herein.

In a non-limiting example, the state machine 700 may include an active state 702, a power saving state 704, and a UE detection state 706. The active state 702 may be a default state when the wireless device 400 is first powered up. When in the active state 702, the control circuit 414 may start a first timer T₁ to establish a defined interval. If the control circuit 414 does not detect any active connection and does not receive any RACH message at expiration of the T₁ timer, the control circuit 414 can thus cause the wireless device 400 to transition to the power saving state 704.

Upon entering the power saving state 704, the control circuit 414 may start a second timer T₂ to establish a second defined interval longer than the defined interval established by the first timer T₁. The control circuit 414 can cause the wireless device 400 to transition to the UE detection state 706 at expiration of the second timer T₂ or in response to receiving the indication signal 436.

Upon entering the UE detection state 706, the control circuit 414 may start a third timer T₃ to establish a third defined interval longer than the second defined interval established by the second timer T₂. The control circuit 414 can cause the wireless device 400 to transition to the active state 702 in response to receiving a RACH message or the indication signal prior to expiration of the third timer T₃. Alternatively, the control circuit 414 can cause the wireless device 400 to transition back to the power saving state 704 in response to not receiving the RACH message at expiration of the third timer T₃.

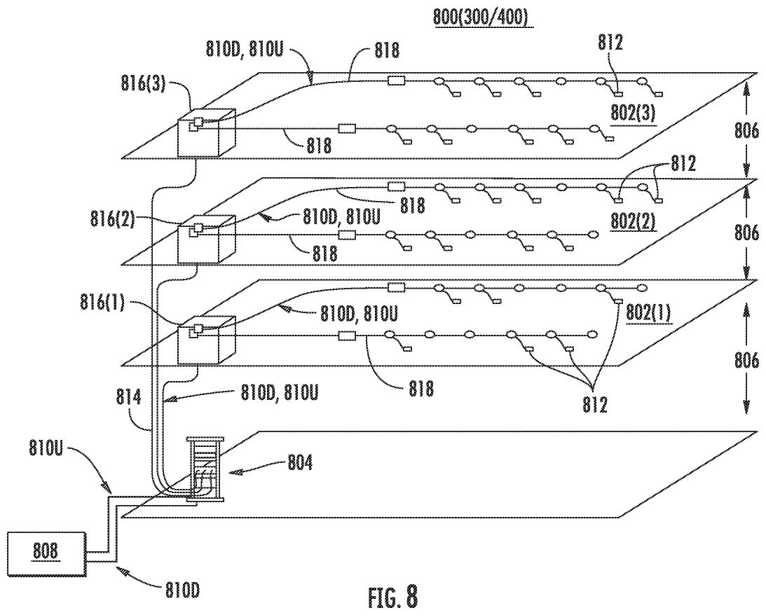

The WCS 300 of FIG. 3, which can include the wireless device 400 in FIG. 4, can be provided in an indoor environment as illustrated in FIG. 8. FIG. 8 is a partial schematic cut-away diagram of an exemplary building infrastructure 800 in a WCS, such as the WCS 300 of FIG. 3 that includes the wireless device 400 of FIG. 4. The building infrastructure 800 in this embodiment includes a first (ground) floor 802(1), a second floor 802(2), and a third floor 802(3). The floors 802(1)-802(3) are serviced by a central unit 804 to provide antenna coverage areas 806 in the building infrastructure 800. The central unit 804 is communicatively coupled to a base station 808 to receive downlink communications signals 810D from the base station 808. The central unit 804 is communicatively coupled to a plurality of remote units 812 to distribute the downlink communications signals 810D to the remote units 812 and to receive uplink communications signals 810U from the remote units 812, as previously discussed above. The downlink communications signals 810D and the uplink communications signals 810U communicated between the central unit 804 and the remote units 812 are carried over a riser cable 814. The riser cable 814 may be routed through interconnect units (ICUs) 816(1)-816(3) dedicated to each of the floors 802(1)-802(3) that route the downlink communications signals 810D and the uplink communications signals 810U to the remote units 812 and also provide power to the remote units 812 via array cables 818.

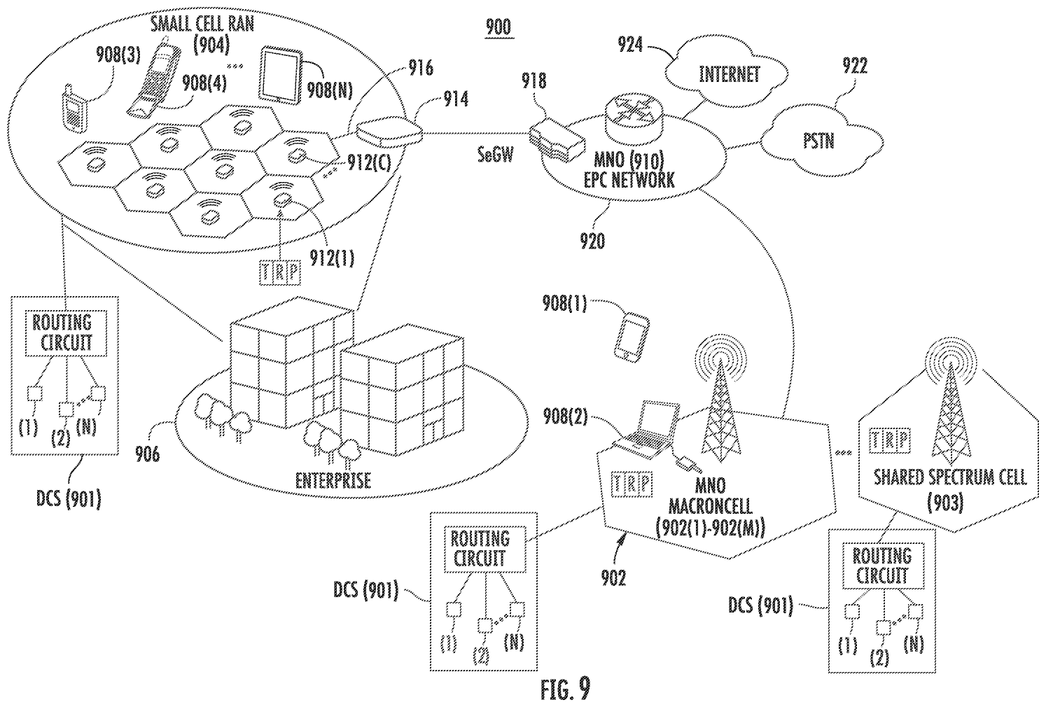

The WCS 300 of FIG. 3 and the wireless device 400 of FIG. 4 configured to enable dynamic power saving in the wireless device 400 can also be interfaced with different types of radio nodes of service providers and/or supporting service providers, including macrocell systems, small cell systems, and remote radio heads (RRH) systems, as examples. For example, FIG. 9 is a schematic diagram of an exemplary mobile telecommunications environment 900 (also referred to as “environment 900”) that includes radio nodes and cells that may support shared spectrum, such as unlicensed spectrum, and can be interfaced to shared spectrum WCSs 901 supporting coordination of distribution of shared spectrum from multiple service providers to remote units to be distributed to subscriber devices. The shared spectrum WCSs 901 can include the WCS 300 of FIG. 3 that includes the wireless device 400 of FIG. 4, as an example.

The environment 900 includes exemplary macrocell RANs 902(1)-902(M) (“macrocells 902(1)-902(M)”) and an exemplary small cell RAN 904 located within an enterprise environment 906 and configured to service mobile communications between a user mobile communications device 908(1)-908(N) to a mobile network operator (MNO) 910. A serving RAN for the user mobile communications devices 908(1)-908(N) is a RAN or cell in the RAN in which the user mobile communications devices 908(1)-908(N) have an established communications session with the exchange of mobile communications signals for mobile communications. Thus, a serving RAN may also be referred to herein as a serving cell. For example, the user mobile communications devices 908(3)-908(N) in FIG. 9 are being serviced by the small cell RAN 904, whereas the user mobile communications devices 908(1) and 908(2) are being serviced by the macrocell 902. The macrocell 902 is an MNO macrocell in this example. However, a shared spectrum RAN 903 (also referred to as “shared spectrum cell 903”) includes a macrocell in this example and supports communications on frequencies that are not solely licensed to a particular MNO, such as CBRS for example, and thus may service user mobile communications devices 908(1)-908(N) independent of a particular MNO. For example, the shared spectrum cell 903 may be operated by a third party that is not an MNO and wherein the shared spectrum cell 903 supports CBRS. Also, as shown in FIG. 9, the MNO macrocell 902, the shared spectrum cell 903, and/or the small cell RAN 904 can interface with a shared spectrum WCS 901 supporting coordination of distribution of shared spectrum from multiple service providers to remote units to be distributed to subscriber devices. The MNO macrocell 902, the shared spectrum cell 903, and the small cell RAN 904 may be neighboring radio access systems to each other, meaning that some or all can be in proximity to each other such that a user mobile communications device 908(3)-908(N) may be able to be in communications range of two or more of the MNO macrocell 902, the shared spectrum cell 903, and the small cell RAN 904 depending on the location of the user mobile communications devices 908(3)-908(N).

In FIG. 9, the mobile telecommunications environment 900 in this example is arranged as an LTE system as described by the Third Generation Partnership Project (3GPP) as an evolution of the GSM/UMTS standards (Global System for Mobile communication/Universal Mobile Telecommunications System). It is emphasized, however, that the aspects described herein may also be applicable to other network types and protocols. The mobile telecommunications environment 900 includes the enterprise environment 906 in which the small cell RAN 904 is implemented. The small cell RAN 904 includes a plurality of small cell radio nodes 912(1)-912(C). Each small cell radio node 912(1)-912(C) has a radio coverage area (graphically depicted in the drawings as a hexagonal shape) that is commonly termed a “small cell.” A small cell may also be referred to as a femtocell or, using terminology defined by 3GPP, as a Home Evolved Node B (HeNB). In the description that follows, the term “cell” typically means the combination of a radio node and its radio coverage area unless otherwise indicated.

In FIG. 9, the small cell RAN 904 includes one or more services nodes (represented as a single services node 914) that manage and control the small cell radio nodes 912(1)-912(C). In alternative implementations, the management and control functionality may be incorporated into a radio node, distributed among nodes, or implemented remotely (i.e., using infrastructure external to the small cell RAN 904). The small cell radio nodes 912(1)-912(C) are coupled to the services node 914 over a direct or local area network (LAN) connection 916 as an example, typically using secure IPsec tunnels. The small cell radio nodes 912(1)-912(C) can include multi-operator radio nodes. The services node 914 aggregates voice and data traffic from the small cell radio nodes 912(1)-912(C) and provides connectivity over an IPsec tunnel to a security gateway (SeGW) 918 in a network 920 (e.g, evolved packet core (EPC) network in a 4G network, or 5G Core in a 5G network) of the MNO 910. The network 920 is typically configured to communicate with a public switched telephone network (PSTN) 922 to carry circuit-switched traffic, as well as for communicating with an external packet-switched network such as the Internet 924.

The environment 900 also generally includes a node (e.g., eNodeB or gNodeB) base station, or “macrocell” 902. The radio coverage area of the macrocell 902 is typically much larger than that of a small cell where the extent of coverage often depends on the base station configuration and surrounding geography. Thus, a given user mobile communications device 908(3)-908(N) may achieve connectivity to the network 920 (e.g., EPC network in a 4G network, or 5G Core in a 5G network) through either a macrocell 902 or small cell radio node 912(1)-912(C) in the small cell RAN 904 in the environment 900.

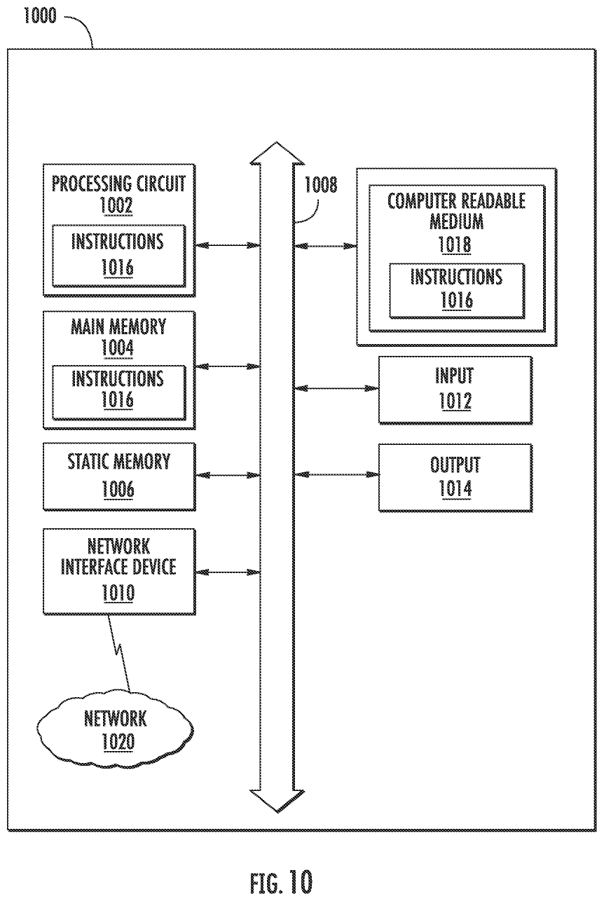

Any of the circuits in the WCS 300 of FIG. 3 and the wireless device 400 of FIG. 4, such as the control circuit 414, can include a computer system 1000, such as that shown in FIG. 10, to carry out their functions and operations. With reference to FIG. 10, the computer system 1000 includes a set of instructions for causing the multi-operator radio node component(s) to provide its designed functionality, and the circuits discussed above. The multi-operator radio node component(s) may be connected (e.g., networked) to other machines in a LAN, an intranet, an extranet, or the Internet. The multi-operator radio node component(s) may operate in a client-server network environment, or as a peer machine in a peer-to-peer (or distributed) network environment. While only a single device is illustrated, the term “device” shall also be taken to include any collection of devices that individually or jointly execute a set (or multiple sets) of instructions to perform any one or more of the methodologies discussed herein. The multi-operator radio node component(s) may be a circuit or circuits included in an electronic board card, such as a printed circuit board (PCB) as an example, a server, a personal computer, a desktop computer, a laptop computer, a personal digital assistant (PDA), a computing pad, a mobile device, or any other device, and may represent, for example, a server, edge computer, or a user's computer. The exemplary computer system 1000 in this embodiment includes a processing circuit or processor 1002, a main memory 1004 (e.g., read-only memory (ROM), flash memory, dynamic random-access memory (DRAM) such as synchronous DRAM (SDRAM), etc.), and a static memory 1006 (e.g., flash memory, static random-access memory (SRAM), etc.), which may communicate with each other via a data bus 1008. Alternatively, the processing circuit 1002 may be connected to the main memory 1004 and/or static memory 1006 directly or via some other connectivity means. The processing circuit 1002 may be a controller, and the main memory 1004 or static memory 1006 may be any type of memory.

The processing circuit 1002 represents one or more general-purpose processing circuits such as a microprocessor, central processing unit, or the like. More particularly, the processing circuit 1002 may be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing circuit 1002 is configured to execute processing logic in instructions 1016 for performing the operations and steps discussed herein.

The computer system 1000 may further include a network interface device 1010. The computer system 1000 also may or may not include an input 1012 to receive input and selections to be communicated to the computer system 1000 when executing instructions. The computer system 1000 also may or may not include an output 1014, including but not limited to a display, a video display unit (e.g., a liquid crystal display (LCD) or a cathode ray tube (CRT)), an alphanumeric input device (e.g., a keyboard), and/or a cursor control device (e.g., a mouse).

The computer system 1000 may or may not include a data storage device that includes instructions 1016 stored in a computer-readable medium 1018. The instructions 1016 may also reside, completely or at least partially, within the main memory 1004 and/or within the processing circuit 1002 during execution thereof by the computer system 1000, the main memory 1004 and the processing circuit 1002 also constituting the computer-readable medium 1018. The instructions 1016 may further be transmitted or received over a network 1020 via the network interface device 1010.

While the computer-readable medium 1018 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding or carrying a set of instructions for execution by the processing circuit and that cause the processing circuit to perform any one or more of the methodologies of the embodiments disclosed herein. The term “computer-readable medium” shall accordingly be taken to include, but not be limited to, solid-state memories, optical and magnetic medium, and carrier wave signals.

Note that as an example, any “ports,” “combiners,” “splitters,” and other “circuits” mentioned in this description may be implemented using Field Programmable Logic Array(s) (FPGA(s)) and/or a digital signal processor(s) (DSP(s)), and therefore, may be embedded within the FPGA or be performed by computational processes.

The embodiments disclosed herein include various steps. The steps of the embodiments disclosed herein may be performed by hardware components or may be embodied in machine-executable instructions, which may be used to cause a general-purpose or special-purpose processor programmed with the instructions to perform the steps. Alternatively, the steps may be performed by a combination of hardware and software.

The embodiments disclosed herein may be provided as a computer program product, or software, that may include a machine-readable medium (or computer-readable medium) having stored thereon instructions, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes a machine-readable storage medium (e.g., read only memory (“ROM”), random access memory (“RAM”), magnetic disk storage medium, optical storage medium, flash memory devices, etc.).

The various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A controller may be a processor. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

We claim:

1. A wireless device, comprising:
a plurality of antenna elements each configured to radiate a downlink communications signal and receive an uplink communications signal in a coverage cell; and
a control circuit configured to:
cause the wireless device to operate in an active mode;
determine if a power-saving condition is present in the coverage cell; and
in response to the power-saving condition being present, cause the wireless device to operate in a power-saving mode.

2. The wireless device of claim 1, wherein the control circuit is further configured to cause the wireless device to operate in the active mode in response to the power-saving condition not being present.

3. The wireless device of claim 2, wherein the control circuit is further configured to:
determine that the power-saving condition is present when all of the following conditions are satisfied:
no user equipment (UE) is currently located in the coverage cell; and
no UE is approaching the coverage cell from outside the coverage cell; and
determine that the power-saving condition is not present when one or more of the following conditions are satisfied:
a UE is currently located in the coverage cell; and
a UE is approaching the coverage cell from outside the coverage cell.

4. The wireless device of claim 3, wherein the control circuit is further configured to:
determine that no UE is currently located in the coverage cell if all of the following conditions are satisfied:
no random-access channel (RACH) message is received withing a defined interval; and
no UE is currently attached to the wireless device; and
determine that at least one UE is currently located in the coverage cell if any of the following conditions is satisfied:
a RACH message is received withing the defined interval; and
at least one UE is currently attached to the wireless device.

5. The wireless device of claim 3, wherein the control circuit is further configured to determine whether there is a UE approaching the coverage cell from outside the coverage cell based on an indication signal received from a centralized services node.

6. The wireless device of claim 2, further comprising:
a transceiver circuit configured to generate the downlink communications signal;
a beamforming circuit configured to convert the downlink communications signal into a plurality of weighted downlink communications signals; and
a power amplifier circuit comprising a plurality of power amplifiers each configured to:
amplify a respective one of the plurality of weighted downlink communications signals; and
provide the respective one of the plurality of weighted downlink communications signals to a respective one of the plurality of antenna elements.

7. The wireless device of claim 6, wherein the control circuit is further configured to selectively deactivate at least a subset of the plurality of antenna elements in the power-saving mode.

8. The wireless device of claim 7, wherein the control circuit is further configured to deactivate the subset of the plurality of antenna elements during a subset of a plurality of timeslots configured for transmitting the downlink communications signal.

9. The wireless device of claim 7, wherein the control circuit is further configured to deactivate at least a subset of the plurality of power amplifiers corresponding to the subset of the plurality of antenna elements.

10. A method for supporting dynamic power saving in a wireless device in a wireless communications system (WC S), comprising:
causing the wireless device to operate in an active mode;
determining if a power-saving condition is present in a coverage cell served by the wireless device; and
in response to the power-saving condition being present, causing the wireless device to operate in a power-saving mode.

11. The method of claim 10, further comprising causing the wireless device to operate in the active mode in response to the power-saving condition not being present.

12. The method of claim 10, further comprising:
determining that the power-saving condition is present when all of the following conditions are satisfied:
no user equipment (UE) is currently located in the coverage cell; and
no UE is approaching the coverage cell from outside the coverage cell; and
determining that the power-saving condition is not present when one or more of the following conditions are satisfied:
a UE is currently located in the coverage cell; and
a UE is approaching the coverage cell from outside the coverage cell.

13. The method of claim 12, further comprising:
determining that no UE is currently located in the coverage cell if all of the following conditions are satisfied:
no random-access channel (RACH) message is received withing a defined interval; and
no UE is currently attached to the wireless device; and
determining that at least one UE is currently located in the coverage cell if any of the following conditions is satisfied:
a RACH message is received within the defined interval; and
at least one UE is currently attached to the wireless device.

14. The method of claim 12, further comprising determining whether there is a UE approaching the coverage cell from outside the coverage cell based on an indication signal received from a centralized services node.

15. The method of claim 11, further comprising selectively deactivating at least a subset of a plurality of antenna elements in the power-saving mode.

16. The method of claim 15, further comprising deactivating the subset of the plurality of antenna elements during a subset of a plurality of timeslots configured for transmitting a downlink communications signal.

17. The method of claim 15, further comprising deactivating at least a subset of a plurality of power amplifiers corresponding to the subset of the plurality of antenna elements.

18. A wireless communications system (WCS), comprising:
a wireless device, comprising:
a plurality of antenna elements configured to radiate a downlink communications signal and receive an uplink communications signal in a coverage cell; and
a control circuit configured to:
cause the wireless device to operate in an active mode;
determine if a power-saving condition is present in the coverage cell; and
in response to the power-saving condition being present, cause the wireless device to operate in a power-saving mode.

19. The WCS of claim 18, wherein the control circuit is further configured to cause the wireless device to operate in the active mode in response to the power-saving condition not being present.

20. The WCS of claim 19, wherein the control circuit is further configured to:
determine that the power-saving condition is present when all of the following conditions are satisfied:
no user equipment (UE) is currently located in the coverage cell; and
no UE is approaching the coverage cell from outside the coverage cell; and
determine that the power-saving condition is not present when one or more of the following conditions are satisfied:
a UE is currently located in the coverage cell; and
a UE is approaching the coverage cell from outside the coverage cell.

21. The WCS of claim 20, further comprising:
a plurality of legacy base stations configured to collectively determine whether the UE is approaching the coverage cell from outside the coverage cell; and
a centralized services node configured to generate an indication signal in response to the plurality of legacy base stations determining that the UE is approaching the coverage cell from outside the coverage cell;
wherein the control circuit is further configured to determine that the UE is approaching the coverage cell from outside the coverage cell in response to receiving the indication signal received from the centralized services node.

22. The WCS of claim 18, further comprising a distributed communications system (DCS), the DCS comprising:
a digital routing unit (DRU) coupled to a centralized services node via a baseband unit (BBU); and
a plurality of remote units each coupled to the DRU via a plurality of optical fiber-based communications mediums, respectively;
wherein:
the DRU is configured to:
receive the downlink communications signal from the centralized services node;
convert the downlink communications signal into a plurality of downlink communications signals;
distribute the plurality of downlink communications signals to the plurality of remote units, respectively;
receive a plurality of uplink communications signals from the plurality of remote units, respectively;
convert the plurality of uplink communications signals into the uplink communications signal; and
provide the uplink communications signal to the centralized services node.

23. The WCS of claim 22, wherein:
the DRU comprises:
an electrical-to-optical (E/O) converter configured to convert the plurality of downlink communications signals into a plurality of downlink optical communications signals, respectively; and
an optical-to-electrical (O/E) converter configured to convert a plurality of uplink optical communications signals into the plurality of uplink communications signals, respectively; and
the plurality of remote units each comprises:
a respective O/E converter configured to convert a respective one of the plurality of downlink optical communications signals into a respective one of the plurality of downlink communications signals; and
a respective E/O converter configured to convert a respective one of the plurality of uplink communications signals into a respective one of the plurality of uplink optical communications signals.
